(19) United States
(12) Patent Application Publication
(10) Pub. No.: US 2015/0323221 A1
(43) Pub. Date: Nov. 12, 2015

(54) Assembly Formed by a Water Heater Comprising a Heating Body Comprising a Volume of Water and at Least One Generator of an Inductive Module Dedicated to an Electrical Appliance

(71) Applicant: WINSLIM, Luxembourg (LU)

(72) Inventor: Jean-Yves Gaspard, Gleize (FR)

(73) Assignee: WINSLIM, Luxembourg (LU)

(21) Appl. No.: 14/421,672

(22) PCT Filed: Aug. 5, 2013
(86) PCT No.: PCT/EP2013/066428

§ 371 Date: Feb. 13, 2015

(30) Foreign Application Priority Data
Aug. 13, 2012 (FR) 12 57789

(51) Int. Cl. F24H 1/12; H05B 6/42; F24H 1/18

(52) U.S. Cl. CPC F24H 1/121; F24H 1/185; H05B 6/42

(57) ABSTRACT

The present invention relates to an assembly formed by a water heater comprising a heating body comprising a volume of water and at least one power generator of an inductive device dedicated to an electrical appliance. The assembly comprises a heat exchanger between said at least one power generator and an area through which water travels towards or into the heating body of the water heater. Application in the field of domestic electrical appliances, in particular water heaters.

### FIELD OF THE INVENTION

The present invention relates to an assembly formed of a water heater comprising a heating body intended to contain a volume of water, and at least one generator of an inductive module dedicated to an electrical appliance and a method for cooling said generator.

### BACKGROUND OF THE INVENTION

In the following, a water heater means a water storage device which has at least one tank used as a heating body for storing hot water, also often called a cylinder. The water heater according to the invention also means an instantaneous type heating device. The tank is the area where water is heated. The capacity of such tank is more or less important according to the needs which the devices are dedicated to, for example by being associated with one or more of hand sink fixtures, a shower and/or a bath tub, etc.

An electric heater knowingly has a heating element immersed in the tank used as the heating body enabling to heat the water contained therein. Such heating element is often a resistance, usually called “shielded resistance” which has a small size and, thanks to its technology, a particularly small surface of exchange with water. Therefore, the power of the shielded resistance is not very high to prevent either the shielded resistance to cause local boiling, or the shielded resistance to be damaged when it no longer properly exchanges energy with the water to be heated because it is covered with scale.

Scale is present almost everywhere in suspension in water and when the water contained in the tank used as the heating element is heated, the molecular agitation will cause the precipitation of scale or scaling of the shielded resistance and generally the hot parts, among which the piping of the water heater. Scaling is a major problem in water heaters because depending on the characteristics of water, heating after heating, the heating element is covered with scale. This results, on the one hand, in a reduction of the heat exchange with water, and on the other hand, in a reduction of the service life of the heating element which is overheated and is finally destroyed. The deposited scale reduces the transfer of heat to water, and the heating element overheats. If the heating element is heavily scaled, the transfer of heat to water becomes difficult and water is not heated properly either because the thermostat stops the heating before the set temperature for heating water is reached so as to protect the heating element which might be damaged, or the thermostat does not detect the overheating of the heating element which goes on heating element and is consequently damaged.

The result is that the output of water heaters having at least one heating element in the form of a resistance is not very satisfactory. Besides, such heating elements are only regulated by a thermostat and operate in an on-off mode, which is not compatible with the new power production or home automation installations technologies and the association thereof with home automation installations is inadequate.

Such incompatibility is particularly disadvantageous because of the development of green energy and the use of increasingly widespread intelligent energy management systems.

The issue of green energy of the wind turbines or photovoltaic cell types is that the production and use of electricity are difficult to match. A wind turbine will produce on windy days, a photovoltaic cell on sunny days. The needs and the production cannot be matched in such conditions. The solution consists in storing energy as an electric current in batteries, e.g. or as hot water in water heaters.

A problem underlying the present invention is to provide a water heater the power consumption of which is optimized.

### SUMMARY

To achieve this goal, one aspect of the invention provides for an assembly comprising a water heater comprising a heating body intended to contain a volume of water comprising an inlet pipe for the water to be heated and an outlet pipe for the heated water. Advantageously, the assembly comprises at least one power generator, at least one inductive module so configured as to produce an induced current in an electrically conductive element (the at least one inductive module is dedicated to an electrical appliance; the electrically conductive element may also be for example a charge of a heating system), and means for exchanging heat between said at least one generator and an area through which water travels towards or into the heating body. The power generator is associated with at least one inductive module.

The technical effect obtained consists in using the water contained in the water heater for cooling the power generator. Such a water heater is particularly suited to heat exchanges thanks to the quantity of water contained therein or supplied thereto, and the calories thus recovered for cooling the generator are further used to improve the heating of the water contained in the water heater. The temperature difference between the relatively cold water to be heated and the generator is then high, which results in an efficient heat exchange. The heat loss in the generator is transmitted to water and recovered to provide make-up heating of the water contained in the water heater.

Without being restrictive, according to one embodiment of the invention, the inductive device is dedicated to heating the water contained in the water heater. The output is thus significantly increased.

The use of induction heating devices has recently been developed for heating cooktops. Such type of heating device has not been generalized to water heaters though, for several reasons.

The first reason relates to the immersion of the induction heating device in the tank. As a matter of fact, such an induction heating device is more sophisticated than a heating resistance since it comprises electronic elements such as a power generator and windings, for instance an inductive module, which must be perfectly electrically insulated from the water contained in the tank. In one embodiment of the invention, the inductor is immersed in water. Thus, the inductor and the charge are immersed in water and they are therefore both in contact with the water present in the heating body. Advantageously, a space between the inductor and the charge enables water to be present between such two components. The immersion of the inductive device in the heating body of the water heater raises a greater problem than the immersion of a heating resistance. Thus there is a strong prejudice, in the state of the art, against the immersion of an induction heating device in the heating body of a water heater. The invention does not however impose that the inductor should be immersed.

Besides, an inductive device requires a power generator for transforming the low frequency mains current into high frequency current. Such generator comprises electronic components that emit heat, and such losses often require a ventilation of the generator hardly compatible with the cost and the use of such devices which then become noisy, which is a second drawback. It is therefore necessary in many cases to cool the so-called power electronic components of the generator using a heat sink and forced ventilation.

This particularly applies to an induction heating device of a water heater, with said water heater being frequently embedded in a small closed and poorly ventilated space such as a closet, a cabinet or a chest. In his approach to limit the losses of an induction heating device of a water heater as well as to evacuate the heat produced by the components of the generator in operation, the applicant of such application realized that this can extrapolated to any domestic inductive device provided in the vicinity of such heater.

The assembly according to the invention may further at least optionally comprise any one of the following characteristics:
the power generator is arranged at a distance from the remaining portion of the inductive module and near the water heater, with said generator being advantageously accommodated in a receiving case, which electrically isolates it and preferably seals it.
the heat exchanging means are arranged at the inlet pipe of the water to be heated in the heating body. With cold water, the temperature difference between the generator and water is high, which provides a better heat exchange.
the area through which water travels enabling the heat exchange with the exchanging means is arranged as a water circulation circuit toward the heating body.
the exchanging means comprises a jacket connected to the power generator and cooperating, for example surrounding the circulation circuit.
it comprises a complementary circuit going through the power generator and by-passing the portion of the inlet pipe of the water to be heated.
the heat exchanging means comprises a sleeve advantageously made integral with the receiving case and surrounding or composing a portion of said inlet pipe of the water to be heated. Thus, the heat exchanging means is integrated in the case, which enhances the heat exchange.
the assembly comprises heat exchanging means, with the generator, more precisely a heat sink, being arranged next to the heating body over a not thermally insulated area, with the heat exchanger being arranged between the outer part of the heating body arranged next to the generator. The heat exchange thus obtained, although less efficient than the previous one, has the advantage of not involving a specific adaptation for the generator. The heat exchanging means may be used in addition or as an alternative to the previously mentioned heat exchanging means.
the means for exchanging heat with the area through which water travels to the heating body comprises a non-thermally insulated area of the heating body which the generator is attached to.
the water heater comprises a hatch for introducing means for heating water in the heating body, with said hatch being closed by a cover plate, with said cover plate being an area advantageously not thermally insulated, advantageously from the outer part, of the heating body which the generator is attached to.
the means for exchanging heat with the area through which water travels in the heating body comprises a case for housing the generator, more precisely the heat sink, immersed in the heating body of the water heater.
the generator has an interface provided with communication means enabling the remote control of the heating parameters such as power, heating time, triggering or stopping of the heating, for example according to various parameters among which, for example the availability of green energy. The control of at least some of the electrical appliances present is thus obtained for a better consumption of energy.
said at least one generator comprises at least two electrical outputs, each one for an inductive module dedicated to an electrical appliance. Said generator is common to at least two electrical appliances. This means saving space and a reduction in the cost for both electrical appliances.
at least two generators are provided, with each generator being dedicated to a specific electrical appliance. Thus, the generators of a plurality of electric appliances can be cooled using a water heater, and such efficient cooling can also be used to increase the number of calories recovered for a make-up heating of the water heater.
the generator is so configured as to enable the alternative power supply of the inductive modules which it is connected to.
the generator is so configured as to enable the simultaneous and total supply of the inductive modules which it is connected to.
an inductive device comprises an inductive module dedicated to heating the water contained in the heating body of the water heater, said inductive module comprises an inductor and at least one charge, with the inductor being so configured as to generate an induced current in the charge, with the inductor and at least one charge being immersed in the heating body.
the assembly comprises a plurality of juxtaposed longitudinal channels fluidly connected to one another, with at least one longitudinal channel housing an inductive module of the induction heating device
the heating body is a preferably rectangular parallelepiped.
the heating body has a capacity above 10 litres and preferably above 20 litres.

The invention also relates to a method for cooling at least one power generator of an inductive device, comprising at least one inductive module dedicated to an electrical appliance and means for exchanging heat between said at least one generator and an area through which water travels towards or into the heating body characterised in that it comprises a step of heat exchange between the area through which water travels towards or into the heating body of the water heater and said at least one generator, with such step contributing to the cooling of said at least one generator while enabling the make-up heating of the water in the area through which water travels towards or into the heating body of the water heater.

Thus, the step of cooling a generator is carried out without involving a cooling system evacuating the energy to the environment, but with the energy being recovered by the make-up heating of the water heater. This is possible because the power components used in the generator 7 can operate at 175° C. at the silicon i.e. 120° C. at the heat sink whereon they are fixed. Even though the temperature of water is 60-70° C., it remains below a maximum temperature of the heat sink with a difference of 50-60° C., which makes an efficient heat exchange possible by a simple contact of the heat sink with water.

Advantageously, as said generator is common to the induction heating device of the water heater and another electrical appliance, a step of controlling the parameters of the induction heating of the water heater is performed according to the real time or estimated operating conditions of the other electrical appliance.

This contributes to the control and coordination of the power consumption of various electrical appliances by a device centrally managing the consumptions planned for the apartment or the building concerned wherein said appliances are installed.

Another severable aspect of the invention is an assembly comprising a water heater comprising a heating body intended to contain a volume of water, comprising an inlet pipe for the water to be heated and an outlet pipe for the heated water such that the assembly comprises at least one power generator, and a plurality of inductive modules so configured as to generate, each, an induced current in an electrically conductive member, with the power generator supplying each one of the inductive modules. The power generator is thus shared. At least one of the inductive modules may for example be selected among: a module for heating the water of the water heater, an induction cooktop(s) heating module, a contactless batteries recharging module. This aspect of the invention can be combined with any other aspect of the invention, in particular the heat exchanging means. The electrical appliances can be remote from each other as the generator can be remote from the appliances and/or the water heater.

### BRIEF DESCRIPTION OF THE DRAWINGS

Other features, objects and advantages of the present invention will be best understood upon reading the detailed description which follows and the appended drawings given by way of non-limiting example and wherein:

FIG. 1 is a schematic representation of a longitudinal section of one embodiment of a part of an assembly according to the present invention, with the water heater being flat and provided with an induction heating device; it should however be kept in mind that a power generator 7 may be cooled using other types of water heaters than a flat water heater,

FIG. 2 is a schematic representation of a front view of the assembly according to one embodiment of the invention, with the water heater being flat and provided with an induction heating device,

FIG. 3 is a schematic representation of a longitudinal sectional view in perspective of one embodiment of an assembly according to the present invention, with the water heater being flat and provided with an induction heating device,

FIG. 4 is a schematic representation of a longitudinal view in perspective of one embodiment of an inductive module with a coil having an oblong shape and a charge plate having a substantially rectangular shape according to the present invention,

FIG. 5 is a schematic representation of a perspective view of an inductive module according to FIG. 4 with two charge plates.

### DETAILED DESCRIPTION

In the following, an inductive device for heating the water contained in a water heater will be taken as an example. Although this is a preferred application of the present invention, such application is not restrictive and the present invention relates to any domestic inductive device, whether for heating a domestic appliance or for another function.

Such an inductive device may be, for example, a heating device for cooktops or an oven. It may also be an inductive device for charging the battery(ies) of a motor vehicle, particularly a hybrid or electric vehicle.

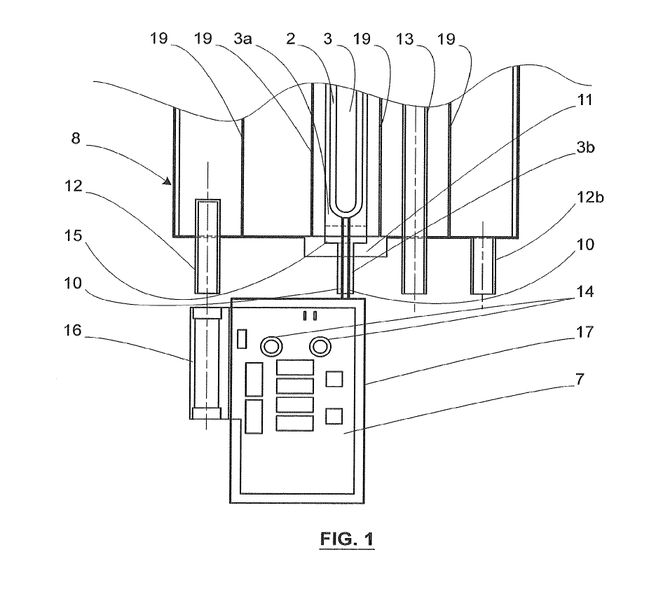

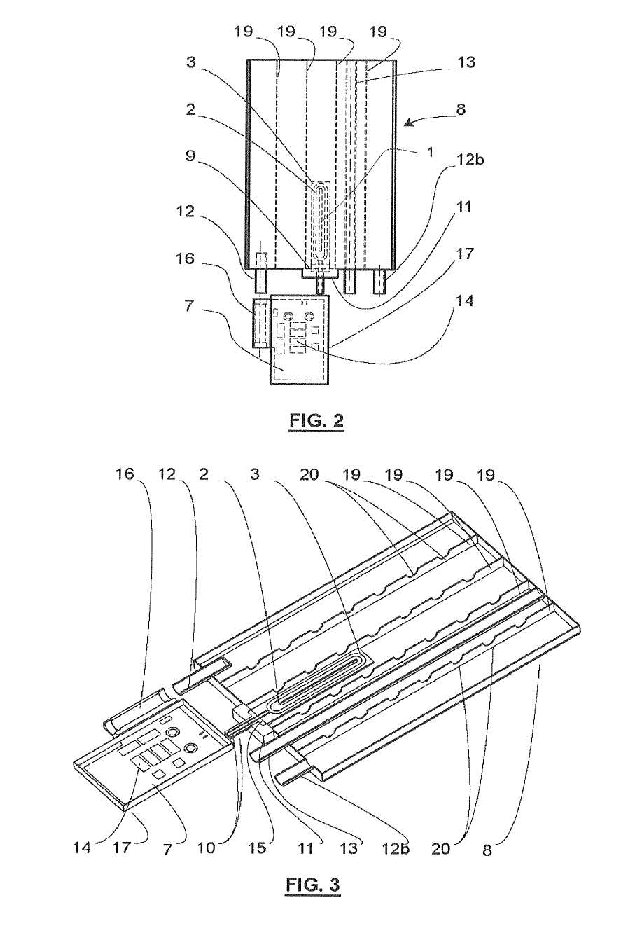

The water heater illustrated in FIGS. 1 to 3 comprises a heating body intended to contain a volume of water, an inlet pipe 12 for the water to be heated, an outlet pipe 13 of the heated water and advantageously a bleed pipe 12b for enabling the complete emptying of the heating body. Advantageously, the water heater is the storage type, i.e. there is no dynamic circulation of water. The water heater then has heating phases and water drawing phases which are generally different and unrelated. The inlet pipe 12 of the water to be heated advantageously opens in the lower portion of the heating body, preferably close to the inductive module for heating water. The heated water outlet pipe 13 advantageously enables to collect water in the upper part of the heating body.

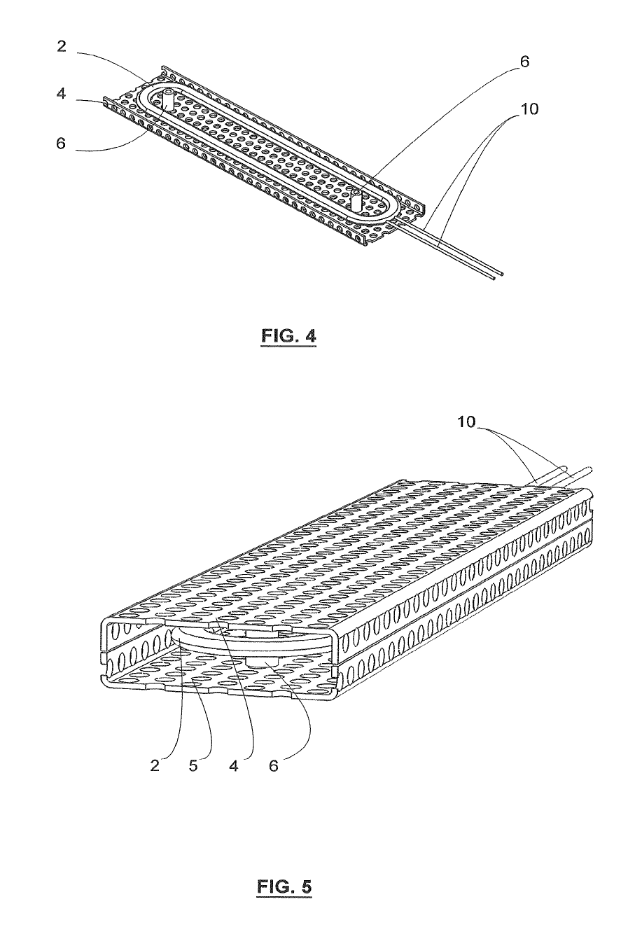

In general, while referring to FIGS. 1-5, it should be reminded that an inductive device 1 uses a power generator 7 for transforming the low frequency mains current, of usually 50-60 HZ, into high frequency current. Such current is used to supply an inductor 2 in the form of at least one induction coil mainly composed of a conductive winding, optionally of magnetic circuits, electrical and thermal insulators.

The power generator 7 comprises a printed circuit whereon various components are assembled among which power components the losses of which are emitted as heat. Such power components are thermally connected to a heat sink preferably made of aluminum. Such heat sink is so configured as to dissipate the heat emitted by the power components so as to prevent the overheating thereof. The generator 7 can be accommodated in a housing case 17 intended to protect it and/or electrically isolate it and/or insulate it from water. The housing case 17 defines the outer contour of the generator and may have for example a substantially rectangular or even circular shape.

The coil 2 passed through by the high frequency current generates a high frequency magnetic field in its close environment. The coil 2 is advantageously carried by a support 3.

For a heating device, an electrically conductive object, commonly called a charge 4, 5 and immersed in the variable field, is passed through by induced currents, known as eddy currents, which will cause its heating by Joule effect. Advantageously, the charges 4, 5 are in the form of charge plates surrounding the inductor 2. The plates may be two separate plates arranged symmetrically relative to the plane of the inductor 2 or a single part so folded as to form two symmetrical charges relative to the plane of the inductor 2. The charge plates 4, 5 are held away from the inductor 2 by advantageously electrically insulating spacers 6, for example distributed across the plates 4, 5 advantageously having a rectangular shape or in a central position of the plates 4, 5.

The inductor 2 assembly composed of at least one coil and at least one charge 4, 5 advantageously as a magnetic plate is called an inductive module.

The charge plates 4, 5 are advantageously fixed to the support 3 preferably by the spacers 6.

An inductive device 1, more particularly a heating device, incurs losses which may represent 5% of the transmitted power, or more if the winding of the coil 2 is produced under high economic constraints. Such losses often require ventilating the device 1 and mainly its power generator 7 and its inductor 2 as a coil. This makes the cost of such a device 1 prohibitive if it is placed outside its associated appliance, here the water heater 8 for heating the water contained in the heating body, since it makes the use of the device noisy.

It is also necessary in many cases to cool the so-called power electronic components of the generator 7 of the induction device 1 using a heat sink and forced ventilation. Such components also have a non-negligible level of loss which plays a part in reducing the efficiency of the induction device 1.

According to the present invention, cooling the power generator of at least one inductive device using a water heater, with said inductive device not being specifically dedicated to heating the heater although this is the preferred function thereof, is provided. Thus, the method for cooling a power generator of an inductive device so configured as to cooperate with a water heater for cooling the power generator is characterized by a step of heat exchange between an area through which water travels towards or into the heating body of the water heater 8 of the at least one generator 7, with such step contributing to the cooling of said at least one generator 7 while enabling the make-up heating of the water contained in the heating body of the water heater 8.

The area through which water travels may be, according to one possibility, a passage area of the water contained in the heating body. The passage area of the water may alternately be a passage area of the water not yet introduced into the heater. Combining the two cooling methods is possible. Travelling water means that the water in contact with the area undergoes a convection effect due to the heat exchange and/or circulation due to the incoming of water in the heating body. More specifically, this area can be called an area with water, preferably, this refers to water to be heated i.e. at a lower temperature than the water having already been heated.

Such inductive device, the generator 7 of which is cooled by the water from the water heater 8, is dedicated to the operation of one or several appliances advantageously located in the vicinity of the water heater 8.

According to one possibility, an inductive device comprises a power generator 7 common to at least two inductive modules which may be dedicated to a single appliance or to distinct appliances.

Advantageously, at least one inductive module is dedicated to the heating of the water heater 8, and comprises an inductor 2 and at least one charge 4, 5, and is advantageously immersed in the heating body of the water heater 8.

Advantageously, the water intended to be heated by the water heater 8 provides the cooling of the power generator 7 of the inductive module intended for the water heater as well as at least another inductive module.

Advantageously, the device 1 for the induction heating of the water heater has a power generator 7 common with that of one or more other inductive module(s) dedicated to one or more appliance(s) other than the water heater 8.

In an alternative solution, the water intended to be heated by the water heater provides the cooling of the power generator 7 of the inductive module intended for the water heater as well as at least another power generator connected to at least another inductive module dedicated to the water heater or another appliance.

According to one embodiment, the power generator 7 comprises two electrical outlets enabling a complete and simultaneous supply to the various inductive modules which it is connected to. In another embodiment, the generator has two electrical outlets enabling an alternative power supply to the various inductive modules which it is connected to.

Such arrangement is particularly advantageous in terms of installed capacity since the electrical installation is then calibrated for one generator only and not for several generators, which could exceed the amperage of the conventional supply agreements.

According to one advantageous possibility, the water heater communicates with the electric meter to optimize the absorbed energy.

Several devices can be cited as non-limiting examples of inductive devices the power generator 7 of which is cooled by the water heater 8, with such devices often relating to, but not only, the heating of one or more appliance(s).

A first group of electrical induction appliances which the present invention can be applied to can be formed of appliances such as one or more cooktop(s) and/or the oven, with said cooktop(s) and/or oven being installed in the kitchen, a place where it is not uncommon to have a water heater 8 nearby. In this case, a power generator 7 may be provided for each appliance or a generator 7 common to all the appliances, with each generator or the common generator being arranged near the water heater 8 and thus remote from the cooktop(s) or and/or the oven. The inductive module positioned near the induction appliance, then advantageously has a significantly reduced thickness because it has no power generator.

This solution has many advantages, such as reducing the overall size of the appliance or of each appliance, not requiring being embedded, increasing the thermal resistance of the appliance and inductive module assembly in that it provides no regulation of the generator 7 at the appliance. Advantageously, in the case of such appliances as cooktops and/or an oven, using the same generator 7 and even, where appropriate, coupling it with the generator 7 is possible for heating the water heater 8 by induction, which, on the one hand, makes it possible to reduce all the equipment costs and on the other hand, to optimize the installed electrical power.

As a matter of fact, the utilisation time of a cooktop or an oven is short, with the average being between 30 minutes and 1 hour. The generator 7 of the water heater 8 can thus be used meanwhile without affecting the volume of hot water, and such phase can even be anticipated by a device managing the energy of all the appliances installed in the apartment or the building containing said electrical appliances learning that the water heater 8 is very likely to be used in such time slot, if known.

A step of controlling the parameters of the induction heating of the water heater 8 according to the real time or estimated operating conditions of the other electrical appliance is thus advantageously executed, since the generator 7 is common to the induction heating device 1 of the water heater 8 and to another electrical appliance.

A second group may comprise a device for charging an electric or hybrid vehicle, with a water heater 8 being installed in the garage, which is a frequent place for charging the vehicle. For example, for an induction charging of 8 hours at 3,000 Watts, a power generator 7 cooled by the water heater 8 can be used, with the generator 7 being advantageously provided with several outlets and possibly used for example for heating the water heater 8, without this being restrictive. In this case, it is necessary to manage the use of the generator 7 between the charging device 1 and the heating device, since both devices require long operation times. With a yield of the charging electronics of 95%, 150 W in 8 hours i.e. 1,200 Whr could theoretically be recovered for heating the water of the water heater 8, which is significant.

A third group may be formed by various household appliances operable by induction. Such appliances can be powered by one of the power generators 7 cooled by the water heater 8, advantageously by a single generator.

Various embodiments for cooling a power generator 7, in the non-limiting case of a device for the induction heating of a water heater, will now be described in greater details.

The induction heating device 1, illustrating any inductive device according to the present invention which is not specifically dedicated to heating the water heater can be positioned close to and in the central lower part of the water heater 8, with the generator 7 being placed outside, advantageously below the water heater 8 when the latter extends vertically.

One advantageous possibility consists in providing an induction kit, namely, a cover plate 11 closing the hatch 9 described below, which supports on one side the inductive module and on the other side, the power generator 7. The water heater may thus be provided with induction heating means without any action on the mechanics of the water heater, by simply introducing the kit. For example, the power generator 7 may be round or rectangular, articulated around the cold water inlet pipe 12 and integral with the cover plate 11.

The oblong shape of the coil and more generally of the inductive module facilitates the installation and removal thereof in/from the heating body 9 through the hatch having the smallest dimensions thus improving the pressure resistance of the water heater.

As described below, the round shape of the solenoid coil and the charge thereof in the form of balls forced to move in a confined area subjected to the field of the induction coil, the cage, also has a shape which facilitates the mounting and the disassembling the module in/from the heating body.

Knobs may be provided on a control interface placed on the front of the water heater 8 which may optionally display the operating and status parameters of the water heater 8 and the electric network. Such interface is equipped with a communication module, for example with a local communication network. Such a network makes it possible to exchange information on the consumption of the water heater 8 with the central system managing the electric energy and also to be controlled by such system.

According to the prior art, the generator comprises cooling means of the fan type. The water heater according to the invention comprises heat exchanging means. Advantageously, the heat exchanger is an exchanger with a passage of water, preferably the water to be heated, e.g. the water supplied to the water heater 8 via at least one inlet 12 for the water to be heated.

The heat exchanging means according to the invention comprise the heat sink which the power components are thermally connected to. According to one possibility, the heat sink comprises a portion forming a jacket for evacuating the heat generated during the operation of the generator 7, with the water heater 8. For this purpose, a circuit for water circulation toward the heating body is provided. Jacket means an interface between the water circulation circuit and the power components. The jacket is defined as the heat sink surrounding the water circulation circuit toward the heating body. The circulation circuit is preferably connected to the inlet pipe 12 for the water to be heated.

According to a possibility shown, the jacket is reduced to a sleeve 16 which cooperates with a part of the inlet pipe 12 for the water to be heated. The jacket can be thermally connected to the water circulation circuit or be the water circulation circuit. In the latter case, water flows directly in the jacket.

According to one possibility, the assembly comprises a complementary circuit. A water tap may be provided from the inlet pipe 12 to form a make-up water circulation circuit within the casing 17.

A respectively primary or additional function of the sleeve 16 may be securing the casing 17 of the generator 7 with respect to an inlet water pipe 12, which is advantageous for maintaining the casing 17, without the sleeve 16 being used for evacuating heat out of the generator 7 but being replaced by another heat exchanging means or in addition to such heat exchanging means.

For the cooling thereof, the power generator 7 is thermally integral with the water heater, namely, the heat sink supporting the power components of the generator 7.

According to a preferred embodiment, the generator 7 and more precisely the heat sink is thermally insulated so as to limit the heat exchanges with the outside air and to concentrate the heat exchanges with the area through which water travels towards or into the heating body.

Other configurations of heat exchanges between the power generator 7 and the water to be heated of the water heater 8, i.e. contained or coming into the heating body 8, are also possible.

For example, as an alternative solution or in addition to the water circulation circuit, the generator 7 may be attached to the outside of the heating body on a non-thermally insulated area, with a heat exchanger being advantageously arranged between the heating body and the generator 7, more precisely the heat sink is thermally connected to the heating body.

In an alternative solution, the area of the heating body which is not heat-insulated is the cover plate. The power components of the generator 7 can be thermally connected to the cover plate 11 of the hatch 9 described below, preferably through the heat sink, and dissipating the heat thereof indirectly to the water contained in the heating body. In such alternative solution combined to the presence of the water circulation circuit, the inlet pipe 12 for the water to be heated can be secured to the cover plate 11. The inlet pipe 12 for the water to be heated is preferably made of aluminum and enables an improved heat exchange.

For example, alternately or additionally, the power generator 7 may be arranged so as to be immersed in the heating body of the water heater 8, with or without a heat exchanger being arranged between the water contained in the heating body and the generator 7.

According to an alternative solution, only the heat sink is arranged so as to be immersed in the heating body, with the rest of the generator 7 being outside the heating body. A direct conduction exists between the heat sink and water. For example, a single part made of anodized aluminum extending outside and inside may be used as the connection 12 to the inlet pipe 12 for the water to be heated, as the heat sink for the power components, as the support outside the power generator, as the support inside the inductive module. The advantage of such single part is that it combines the function of the heat sink by conduction and convection through the passage of water to be heated.

The cooling of the generator 7 is possible even with the embodiment comprising a water circuit towards the heating body, even in the absence of filling of the heating body by convection. As a matter of fact, the heat exchange produced by the exchanging means heats the water in the area through which water travels and locally cools the generator 7, more precisely the heat sink, the warmed water in the area through which water travels will undergo convection movements displacing it away from the passage area and displacing closer the water at a lower temperature, thus creating a convective flow. Advantageously, such effect is enhanced by the arrangement of the generator 7 below the tank water of the water heater and the movement of the hot water which goes up toward the tank. According to a preferred possibility, the exchanging means are positioned as close as possible to the heating body.

The inductor 2 of the device 1, advantageously in the form of a flat coil, preferably having an oblong shape connected to the generator 7 by electrical connections 10, along with the support 3 thereof, is preferably positioned inside the water heater 8 for example by entering said water heater 8 through a hatch 9 provided in the central lower part of the water heater 8.

Flat or flattened means that the thickness of the coil is smaller than the other dimensions particularly length, width.

According to one possibility, the inductor 2 extends over a part of the length of the water heater 8. The inductor is arranged in the lower part of the water heater. By way of non-limiting example, the inductor 2 extends on maximum half of the length of the water heater, preferably between one fourth and one eighth of the length of the water heater 8.

According to one embodiment, the support 3 of the inductor 2 has a first part 3b, overmolded around the flat coil forming the inductor 2. Such part 3b is intended to be completely inserted into the water heater 8.

The flat coil forming the inductor is a conductor 2 wound onto itself. The coil advantageously comprises an electrical insulator fitted when manufacturing the coil. For this purpose, the insulator may be a resin also having water insulating properties enabling the direct immersion of the coil in the water heater; the cost of such material is quite high, however. Alternately, the coil is coated with a varnish, preferably of a mean temperature class, since the whole assembly is immersed and the water does not exceed 100° C. Such coil must therefore be insulated from water. For this purpose, the coil is overmolded with a food grade plastic enabling the electrical insulation required for the immersion. Advantageously, the overmolding enables the production of the support 3 in various forms.

Inside the flat coil forming the inductor 2, advantageously at mid-length of the coil, at least one temperature sensor may be provided, for example of the NTC (Negative Temperature Curve) or PTC (Positive Temperature Curve) type, with such temperature sensor being immersed in the water heater 8 and giving temperature values transmitted to the generator 7 of the device 1.

The support 3 also has a second part 3a, narrower than the first portion 3b, with the second part 3a being located outside the water heater 8 and being an extension of the first part 3b towards the generator 7, while carrying the electrical connections 10 only. The junction between the first 3a and the second 3b parts having a smaller width has for example lateral shoulders 15.

The hatch 9 may have for example a rectangular outer shape which makes it substantially different from the hatch having a generally circular shape for the passage of the electric resistance in the water heater of the prior art. The hatch 9 is closed by at least one cover plate 11 fixed to the hatch 9 by means of removable securing means of the screw type, for example by interposing a seal. The cover plate 11 has a central rectangular opening just sufficient for the passage of the second part 3a of the support 3 therethrough, with the shoulders 15 carried by the first part 3b of the support 3 at its junction with the second part 3a internally abutting against the cover plate 11.

The cover plate 11 can be secured directly to the support 3 during the overmolding of the coil 2 with a plastic material.

When the water of the water heater 8 is cold, the power demand will be maximum and thus the energy required is high then, and thus the components of the power generator 7 are then stressed and maintained below about 120° C. The water is then regulated never to exceed 60° C., for example at the bottom of the tank and is therefore used as an excellent heat sink for the losses of such components, which in turn, participate in the output but to a lesser extent than the inductor 2.

When the water begins to warm, the dissipation effect will be reduced as will be the needs in energy, and the components of the power generator 7 can thus be efficiently cooled. This makes it possible to significantly reduce the heat sink and eliminate the ventilation traditionally used in the household induction devices.

In reference to FIGS. 1 to 5, an induction device 1 for heating the water heater 8, with the inductive module being at least partially immersed in the heating body of the water heater 8 will be more specifically disclosed hereinafter as the inductive device.

With a view to at least partially overcoming the losses previously mentioned, the present invention, in one of its embodiments, advantageously provides to house the inductor 2 in the water heater 8, directly in the water contained in the water heater 8, with at least one charge in the form of a plate 4 or 5 also being immersed in water.

This embodiment is based on the observation that the main losses of the induction heating device 1 are caused by the inductor 2. The inductor 2 and at least one charge 4, 5 thus also exchange their losses with water and therefore, such losses are recovered for heating the water of the water heater 8. This complements the heat recovered during the cooling of the power generator 7 as previously mentioned ensuring, however, most of the heating.

The inductor may be similar to an inductor used as an induction cooktop, with the inductor being of the flat coil type and being also called a “pancake”. Such type of coil is perfectly symmetrical, i.e. the magnetic field is generated equally on both faces. One face is traditionally equipped with a magnetic circuit the function of which consists in channeling the generally lower field of the inductor and in sending it back to the charge 4, 5, usually placed on the top of the coil forming the inductor.

When extrapolating such characteristics to the induction heating device 1 of the invention and thus when providing a flat coil generating a magnetic field on both sides, to be used as the inductor 2, a charge 4, 5 to be heated is thus used on each face of the heating coil platform, with such charges 4, 5 having adequate ferromagnetic characteristics. A magnetic circuit in the inductor 2 is no longer required.

This also makes it possible to increase, more precisely to double, the exchange surface and thus to reduce the power densities and thus to get a better exchange of energy with water. The inductor 2 and its charges 4, 5, at least one of which, preferably both, is/are immersed, are thus formed, by way of non-limiting example, as a central flat coil and two ferromagnetic plates 4, 5 magnetically coupled to the coil 2. These two plates 4, 5 are the place where eddy currents are created when the coil 2 is supplied by the generator 1 and are operative to heat the water.

Other forms of induction coil 2 than a flat induction coil on both sides may be envisaged. A coil 2 which can be used within the scope of the invention may be in the form of a solenoid with internal or external charges, i.e. simultaneously internally and externally, to make sure the charges are also used as magnetic circuits as in the case of two charge plates 4, 5.

However, it is more advantageous to have a large exchange surface with a plate configuration. Such configuration also has the advantage of being particularly thin, for example with a thickness of 3 cm, which facilitates the integration thereof in special forms of water heater 8 such as flat or other water heaters that have been recently marketed.

The charges 4 and 5 are made of either magnetic or non-magnetic electrically conductive materials.

Magnetic materials for plates 4, 5 are more advantageous for heating than non-magnetic materials.

The charges 4, 5 may also be made of a conductive and non-magnetic material having a small thickness, with such conductive, non-magnetic materials having a small thickness, of the order of 100 micrometers, preferably being attached to a non-magnetic and non-conductive support providing their mechanical strength.

Such plates 4, 5 may have special shapes or surface conditions making it possible, on the one hand, to improve the heat exchange with water and, on the other hand, to optimize the coupling with the induction coil 2, while avoiding at best the scale deposition.

For example, the plates 4, 5 have through-openings such as circular holes. Such openings improve water circulation around the plates.

It should be considered that, in such case, the plates 4, 5 become the heating elements and that scale thus tends to deposit on the plates 4, 5 and not on the coil 2. This phenomenon is however minimized since, for a given power, the power density is lower and therefore the surface is not so hot. It should also be noted that the risk of breakage of the heating element due to overheating disappears since the plates 4, 5 are purely passive and can not be affected by a possible overheating.

The Curie point is the temperature at which the magnetic permeability of a ferromagnetic material changes to μr=1, the material becomes non-magnetic, the phenomenon of induction acts up to the Curie point of the materials composing the charge plates 4, 5. It may thus be advantageous to produce such plates 4, 5 in a material having a low Curie point preferably below 100° C., for example 90° C. or less, which is merely illustrative and not restrictive.

In this case, the inductor 2 indirectly heats the plates 4, 5 so long as the charge temperature thereof does not exceed 90° C. Beyond this temperature, the material goes beyond its Curie point and becomes non-magnetic, which causes the magnetic flux of the coil not to be channeled in the charge any longer, which results in a very significant reduction of the active part of the coil impedance, which makes the operation of the generator impossible. Heating is resumed after cooling and when the temperature of the material of the plates 4, 5 is below the Curie point, i.e. in its ferromagnetic area.

Producing the plates 4, 5 in such a ferromagnetic material having a low Curie point may result in an absolute additional thermal safety for the inductor 2 and the heating device 1 which contains it.

Optimizing the shape, material and/or the fixing of the plates 4, 5 is also possible so that they are slightly deformed when heated, with the deformation preventing or removing the scale deposits that may cover these. Deformable for instance shape memory materials can be used.

Eventually, it may also be interesting to carry out a surface treatment to ensure the compatibility of the plates 4, 5 with food grade standards and to minimize the scale deposits thanks to nonstick properties.

According to one embodiment incorporating an inductor 2 as a solenoid with internal and/or external charges 4, 5 having a circular section, the charges 4, 5 may be provided as a mobile electrically conductive element held in an area advantageously at least partially matching the action area of the field of the inductor 2. The at least one conductive element is preferably free to move in this area. The at least one conductive element is advantageously so configured as to be moved by the flow of water in the heating body, more precisely in the action area of the field of the inductor 2. To move the at least one element, the supply pipe 12 of water to be heated is preferably placed under the inductor 2, so that the introduction of water into the heating body provides the agitation of the at least one element. Such agitation restricts the scale deposition and optionally facilitates the release thereof, specifically thanks to the bumping of the at least one element with at least another element, or with its holding means described hereunder. The at least one element has a shape and/or properties limiting the deposition of the scale and/or facilitating the release thereof. The at least one element is held in the area of action of the field of the inductor 2 by holding means such as a shaft whereon the at least one element is movable along at least one degree of freedom or for example by a cage defining the area wherein the at least one element must be held and leaving it free move to on any degree of freedom.

In one embodiment the at least one element is at least one ball. Preferably, the charges 4, 5 are balls kept in an area advantageously matching at least partially the action area of the field of the inductor 2. Such area is preferably defined by a cage.

The balls are for example made of ferromagnetic materials, which are heated by the effect of the field induced by the inductor 2. The balls may have various shapes: a circular, cylindrical or another section. The balls of the same charge 4, 5 may have various shapes. The balls are so configured as to make it possible, on the one hand to produce a charge and thus a suitable induction heating, and on the other hand to minimize scale deposition and optionally facilitate the release thereof.

The cage is so configured as to enable the balls to move and to bump one another. The very form of the balls advantageously having a circular section, limits scale deposition. Besides, the impacts between the balls facilitate the release of deposited scale. Preferably, the cage of each charge 4, 5 is made of a non-conductive material so as not to heat and not to be exposed to scaling. The cage is so configured as to enable the most efficient possible heat exchange between the balls and water.

For example, the balls are held in an annular area, concentric to the coil.

According to one embodiment wherein at least one charge 4, 5 is in the form of a cage with inner balls arranged inside the inductor in the form of a solenoid, the inner cage is advantageously formed by the solenoid. The balls are placed in the internal volume defined by the solenoid, with the solenoid ends being closed by a wall preferably a grid having a mesh size smaller than the smallest section of the balls so as to retain the balls while letting through the scale released from the balls, if any, and to ensure a suitable flow of water around the balls.

Preferably, the cage with outer balls is composed of at least one tubular grid surrounding the inductor 2.

According to a preferred embodiment, the charges 4, 5, are secured to the cover plate 11 as is the inductor 2, so as to facilitate the positioning and removal of the inductive module.

The structure of such charges 4, 5 is advantageous since it facilitates the circulation of water in and around the inductive module.

The balls have a size for example of the order of 15 mm. Each charge 4, 5 may be composed of 10 to 30 balls. The exchange surface is at least comparable to that of a rectangular charge.

The balls are preferably light to facilitate the stirring thereof. Besides, the phenomenon of induction occurs on a so-called “skin” thickness. The thickness of the conductive material of the at least one conductive element can thus be reduced.

The following description is made while referring to the ball without it inducing any limitation. A ball may be solid or hollow with only a shell made of a conductive material. The charge may be composed of various types of balls.

As regards magnetic materials, a thickness of 0.5 mm for a field frequency of 20 KHz is enough, with the core being hollow or made of a preferably lighter material than that of the conductive material.

As regards non-magnetic materials, the ball preferably comprises a non-magnetic conductive thin shell so as not to return inadequate impedance to the inductor. In this case, the thickness of the shell is preferably smaller than the thickness of the skin, as preferred example in the range of 1/10 of the thickness of the skin. The core is hollow or made of a non-conductive material and preferably lighter than that of the conductive material.

Ferritic balls are simultaneously exposed, at the considered frequency, to an attractive effect resulting from their magnetic permeability and to a repulsive effect resulting from the induced currents, with the resultant being almost zero. On the contrary, the non-magnetic balls the conductive layer of which has a thickness of about one tenth of the skin thickness are exposed to the repulsive force resulting from the induced currents, called Laplace force only. Depending on the weight of the balls this force may be sufficient to cause them to move and their bumping together has a descaling effect, such phenomenon being accentuated if it is added to the water flow generated by the outlet of the inlet pipe 12 for the water to be heated.

The interest of an inductor 2 immersed in the water of the water heater 8 is that a complete electronic system is available, which enables:
a very fine control of temperature using at least one submerged NTC sensor, i.e. in the form of a thermistor the resistance of which decreases with temperature. Alternately, a PTC sensor can be used, i.e. in the form of a thermistor the resistance of which increases with temperature. The temperature can then be controlled with preset heating cycles or even an anticipation of the demand for hot water at specific times or calculated by learning; as a matter of fact, the existing water heaters are equipped with thermostats which are set in factory or by the installer once and for all, and are not adjustable by the user. It is known that the warmer the water, the higher the loss by natural cooling, and it may thus be interesting, with the aim of minimizing losses, not only to plan heating as needed by learning, but also to adjust, according to such needs, the temperature(s) of the heating body on optimal values and/or
to know and finely control the power injected into one or more inductors 2.

This last advantage is particularly important in the case of new energies and the use thereof. As a matter of fact, it is possible to quickly communicate with the energy management systems to match the energy taken and the available energy on the one hand, and on the other hand, to finely regulate energy until very low and/or very high powers are obtained, while maintaining a high output.

An inductor 2 immersed in the water of the water heater 8 is particularly advantageous with respect to an inductor which directly heats the tank used as the heating body. As a matter of fact, it enables to electrically insulate the plates 4, 5 receiving energy from the heating body and therefore of the ground and thereby significantly reduce the size of the electronic filters aiming at eliminating the rejection of the high frequencies components to the power net or to the ground.

The inductor 2 can thus be particularly compact, which facilitates the integration thereof and also makes it very economical.

It may be possible to save even more on the cost of the induction heating device, specifically on the inductor 2. This can be done, for example, by producing a less complicated winding than imposed by the rules of the art. This can be done by minimizing, for example, the section of the winding or by producing the winding using a solid conductor or even a power printed circuit.

In such case, the losses are greater, but are calculated so as to be acceptable for the device 1 knowing that they are transmitted to water and therefore are transformed into recovered energy.

According to the state of the art, many methods exist for achieving magnetic scale inhibitors, using either permanent magnets or coils creating magnetic fields varying in frequency ranges up to 100 kHz. Electronic scale inhibitors using such principles, although expensive, have a rather low power, equal to no more than a few tens of Volt-ampere and generate weak fields of a few tens of amperes/meter.

On the contrary, the immersed inductor 2, used in the device according to the present invention, has a high power of several thousands of Volt-amperes and generates particularly high fields, greater than 1,000 amperes/meter in the air gap of the coil and the plates 4, 5 and in the same frequency ranges of 20-50 kHz. It may therefore be advantageous to ensure that the cold water or simply a water passage is provided between the plates 4, 5, so that water can go through a strong magnetic field, which may act on the ions suspended in water and cause the absence of deposition of such ions on hot elements, i.e. have a descaling effect. This may thus be a beneficial consequence resulting from the adoption of the inductor 2 immersed in the water heater 8, but this is not the main effect desired.

It is possible to force the passage of water between the plates 4, 5 by selecting particular geometries, for example, by folding one of the sides of the plates 4, 5, so that the two facing plates 4, 5 form a kind of rectangular box at the centre of which the induction coil 2 is arranged and through which the incoming cold water of the water heater 8 passes.

A closed form of this type can also be interesting within the scope of the use of tanks used as heating bodies made of non-metallic or composite materials. In this case, the magnetic field emitted by the coil must be channeled at best. A closed geometry advantageously enables the channeling of the magnetic flux and thus makes it easier to meet the standards relating to electromagnetic interference.

By way of illustrative and non-limiting example, the invention was applied to a 100-liter water heater 8. In the induction heating device, the inductor 2 is a series half-bridge type inverter with a maximum power of 3,700 Watt corresponding to a current of 16 amperes at 230 volts.

The inductor 2 is, as an illustrative and not limiting example, a flat coil 55×340×4 mm in dimensions, positioned vertically in the water heater 8. The flat coil 2 consists of 24 turns of multi-strand enameled wire providing the first electrical insulation, with the number of turns and the distance from the plates 4, 5 making it possible to return to the resonance power generator 7 an impedance compatible with the power to be transmitted.

Advantageously, the induction coil is a winding of a divided wire strand or a solid conductor made of copper or aluminum. The winding is then overmoulded in an electrically insulating material providing the insulation required by the immersed component, with the material in contact with water also having food grade characteristics. An NTC-type component is positioned at the centre of the winding and moulded therewith. It provides, as a sensor, the reading of the temperature which will enable a fine regulation of the inductor 2.

Two Ferritic plates, having a thickness which may advantageously vary between 6/12 and 12/10 and being folded at 90° on one side to form a parallelepiped when mounted face to face, are positioned on either side of the inductive winding at a distance of 6 mm, thus letting water through between the plates 4, 5 and the inductor 2. Advantageously, the dimensions of the plates 4, 5 are 380×70 mm.

The plates 4, 5 are secured to the support 3, advantageously made of plastic or composite material, by means of central spacers 6, with the support 3 itself being at least in abutment or integral with the cover plate 11 of the inspection hatch 9 of the water heater 8, so that the plates 4, 5 are electrically floating. An anti-adhesive coating is applied to the plates 4, 5 in order to limit the deposition of scale during the successive heating cycles. It is advantageous to provide forms and cut-outs on the plates 4, 5 in order, on the one hand, to optimize the circulation and the heating of water and, on the other hand, to further reduce the catching of scale deposits.

The inductor 2 and the temperature sensor are electrically connected to the generator 7, advantageously secured to the other side of the cover plate of the hatch 9 and thus outside the water heater 8.

Such flat heater, i.e. having a substantially parallelepiped shape, preferably a flattened rectangular shape, comprises at least one inlet pipe 12 for the water to be heated, an heated water outlet pipe 13 and a water bleed pipe 12b, especially for emptying the water heater 8.

According to one embodiment, regularly spaced intermediate walls 19, for example, four intermediate walls 19 in a water heater 8 extend throughout the length of the heater 8.

Such intermediate walls 19 have a width equivalent to the thickness of the water heater 8 thus defining longitudinal channels for the passage of water. The inductive module of the induction heating device 1, which non-restrictively illustrates an inductive device the generator of which is cooled by the water heater 8 is positioned in such channel, advantageously the one which is in the middle of the water heater 8.

The intermediate walls 19 preferably have for example regularly spaced openings 20 enabling intercommunication between two adjacent longitudinal channels. Such intermediate walls 19 are used to reinforce the water heater 8 and for the circulation of water in the heating body.

In another embodiment, the longitudinal channels correspond to a plurality of tanks. In a preferred embodiment, the tanks have a circular section. For example, the water heater 8 may be composed of three tanks used as cylindrical elementary heating bodies, advantageously such tanks have a section with dimensions substantially equivalent to the dimensions of the rectangular section of a longitudinal channel.

### REFERENCES

1. Device
2. Inductor
3. Support plate
3a. First part
3b. Second part
4. Charge
5. Charge
6. Spacer
7. Generator
8. Water heater
9. Hatch
10. Electrical connection
11. Cover plate
12. Inlet pipe
12b. Purge line
13. Outlet pipe
14. Component
15. Shoulder
16. Sleeve
17. Case
19. Partition wall
20. Opening

1. An assembly formed by a water heater comprising a heating body intended to contain a volume of water, comprising an inlet pipe for the water to be heated and an outlet pipe for the heated water, wherein the assembly comprises at least one power generator, at least one inductive module so configured as to produce an induced current in an electrically conductive element, and a heat exchanger between said at least one generator and an area through which water travels towards or into the heating body.

2. The assembly according to claim 1, wherein the area through which water travels which enables the heat exchange with the heat exchanger is arranged as a water circulation circuit toward the heating body.

3. The assembly according to claim 2, wherein the heat exchanger comprises a jacket connected to the at least one power generator and surrounding the circulation circuit.

4. The assembly according to claim 2, comprising a complementary circuit going through the at least one power generator and arranged as a by-pass to a portion of the inlet pipe for the water to be heated.

5. The assembly according to claim 1, wherein the heat exchanger with the area through which water travels in the heating body comprises a non-thermally insulated area of the heating body which the at least one power generator is attached to.

6. The assembly according to claim 5, wherein the water heater comprises a hatch for the introduction of the heat exchanger for heating the water in the heating body, with said hatch being closed by a cover plate, with said cover plate being a non-thermally insulated area of the heating body which the at least one power generator is attached to.

7. The assembly according to claim 1, wherein the heat exchanger with the area through which water travels in the heating body comprises of the at least one power generator housing immersed in the heating body of the water heater.

8. The assembly according to claim 1, wherein the at least one power generator has at least two electrical outputs, with each one being intended for an inductive module dedicated to an electrical appliance.

9. The assembly according to claim 1, wherein the at least one inductive module comprises an inductive module dedicated to heating of the water contained in the heating body of the water heater, with said inductive module comprising an inductor and at least one charge, with the inductor being so configured as to generate an induced current in the at least one charge.

10. The assembly according to claim 9, wherein the inductor and the at least one charge are introduced into the heating body so as to be able to be immersed in water.

11. The assembly according to claim 10, wherein the heating body comprises a plurality of juxtaposed longitudinal channels fluidly connected to each other, with at least one longitudinal channel receiving the inductive module dedicated to water heating.

12. The assembly according to claim 8, wherein the at least one inductive module comprises an inductive module dedicated to the heating of at least one induction cooktop.

13. The assembly according to claim 1, wherein the heating body is a parallelepiped.

14. A method for cooling at least one power generator of an inductive device, comprising at least one inductive module dedicated to an electrical appliance, wherein it comprises a step of exchanging heat between an area through which water travels into or towards a heating body of a water heater and the at least one power generator, with such step contributing to cooling of the at least one power generator while enabling a make-up heating of the water in the area through which water travels towards or into the heating body of the water heater.
